(19) United States
(12) Patent Application Publication
(10) Pub. No.: US 2022/0348731 A1
(43) Pub. Date: Nov. 3, 2022

(54) TREATING THREE-DIMENSIONAL PRINTED OBJECTS WITH TREATMENT AGENT

(71) Applicant: HEWLETT-PACKARD DEVELOPMENT COMPANY, L.P., SPRING, TX (US)

(72) Inventors: Emre Discekici, Spring, TX (US); Shannon R. Woodruff, Spring, TX (US); Alay Yemane, Spring, TX (US)

(21) Appl. No.: 17/245,501

(22) Filed: Apr. 30, 2021

(51) Int. Cl. C08J 7/12; C08K 3/04; B29C 64/165; B29C 64/35; B33Y 10/00; B33Y 40/20; B33Y 70/00

(52) U.S. Cl. CPC C08J 7/12; C08K 3/04; B29C 64/165; B29C 64/35; B33Y 10/00; B33Y 40/20; B33Y 70/00; C08J 2377/06; B29K 2077/00

(57) ABSTRACT

The present disclosure includes a three-dimensional printed object comprising a fusing agent, a polymeric build material and a treatment agent further comprising water or an aqueous solution of methyl 4-hydroxybenzoate. It further includes a method of enhancing mechanical properties of said three-dimensional printed article as well as a method of creating a treated three-dimensional printed object.

### BACKGROUND

Three-dimensional (3D) printing is a term synonymous with additive manufacturing describing a method and system which builds three-dimensional objects from the selective addition of a build material. This is in contrast to traditional machining processes which usually rely on the removal of material to create the final part. Some 3D printing methods use chemical binders or adhesives to bind build material while other 3D printing methods involve at least partial curing, fusing or melting of build material. Limitations imposed by the range of materials that can be used in the systems makes it a challenge to print functional parts with desired mechanical properties.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a schematic view of an example three-dimensional printing kit in accordance with the present disclosure.

FIG. 2 is a schematic view of an example three-dimensional printed object being treated with a treatment agent in accordance with the present disclosure.

FIG. 3 is a cross-sectional view of an example three-dimensional printed object prepared in accordance with the present

FIGS. 4A-4C are schematic views of an example three-dimensional printing system in accordance with the present disclosure.

### DETAILED DESCRIPTION

The present disclosure describes three-dimensional printed objects, a method of enhancing mechanical properties of a three-dimensional printed object and and a method of making three-dimensional printed objects treated with a treatment agent as well as a three-dimensional printing kit. The three-dimensional printing kit comprises a fusing agent, a particulate build material which can comprise a polymeric build material including polymeric particles and a treatment agent comprising water. In one example, a three-dimensional printing kit can include a fusing agent having from about 75 wt % to about 99 wt % water, and from about 0.1 wt % to about 15 wt % radiation absorber. The three-dimensional printing kit can further include a polymeric build material and a treatment agent.

The radiation absorber can be selected from carbon black pigments, metal dithiolene complex, a near-infrared absorbing dye, a near-infrared absorbing pigment, metal nanoparticles, a conjugate polymer, a tungsten bronze, molybdenum bronze, or a combination thereof.

The particulate build material which can comprise a polymeric build material can be selected from a group consisting of polyamide-12, polyamide-6, polyamide-66, polyamide-69, polyamide 6-10, polyamide 6-12, polyamide-46, polyamide-1212 and combinations thereof.

The treatment agent in the present disclosure is a fluid that is used to treat the three-dimensional printed objects subsequent to their printing. In one example it can be water. In another example it can be an aqueous solution of methyl 4-hydroxybenzoate (also known as methyl paraben). In yet another example it can be a solution of methyl 4-benzoate in water at a concentration of between about 0.01 wt % and 0.5 wt % based on the total weight of the treatment agent.

The treatment agent can be applied using any known means of application. The treatment agent can be applied by soaking or using an application unit, which can include equipment for applying liquids to a three-dimensional printed object. A liquid application unit can include a tank or well containing liquid for dipping a three-dimensional printed object or sprayers for spraying liquid onto a three-dimensional printed object. In certain examples, a liquid application unit can include a chamber in which a three-dimensional object can be enclosed and internal sprayers within the chamber can apply the liquid to the three-dimensional printed object. Thus, the term “soaking” does not infer that the three-dimensional object is being bathed in the treatment agent (though it may be), but rather that a coating of treatment agent is applied and remains on a surface of the three-dimensional object for the time period of the soaking so that the treatment agent can absorb into the surface during the soaking duration.

In another example, a three-dimensional printed object can include a polymeric body including fused polyamide particles having a radiation absorber embedded as particles among the fused polyamide particles.

In yet another example, a three-dimensional printed object can include a polymeric body including fused polyamide particles having a radiation absorber embedded as particles among the fused polyamide particles in which the polyamide particles are selected from a group consisting of polyamide-12, polyamide-6, polyamide-66, polyamide-69, polyamide 6-10, polyamide 6-12, polyamide-46, polyamide-1212 and combinations thereof.

In another example, a three-dimensional printed object including a polymeric body including fused polyamide particles having a radiation absorber embedded as particles among the fused polyamide particles is submerged in a treatment agent comprising methyl 4-hydroxybenzoate and water for a length of time ranging from 2 hours to several weeks.

In another example, a method of enhancing the mechanical properties of a three-dimensional printed object including a polymeric body including fused polyamide particles having a radiation absorber embedded as particles among the fused polyamide particles can include treatment of a three-dimensional printed object in a treatment agent comprising an aqueous solution of methyl 4-hydroxybenzoate at a temperature from about 0° C. to about 110° C. for a period of time ranging from about 2 hours to about one month. The treatment agent can comprise an aqueous solution of methyl 4-hydroxybenzoate of between about 0 wt % and about 1 wt % methyl 4-hydroxybenzoate and water.

Three-Dimensional Printing Kits

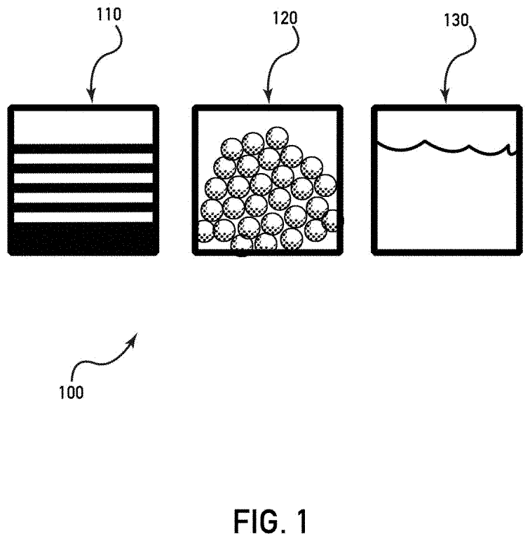

The present disclosure also describes three-dimensional printing kits. The kits can include materials used in the methods and in forming the three-dimensional printed objects described hereinafter. FIG. 1 shows a schematic illustration of one example three-dimensional printing kit (100) in accordance with examples of the present disclosure. The kit includes a particulate build material (110), a fusing agent (120), and a treatment agent (130). In some examples, the fusing agent (120) can include from about 75 wt % to about 99 wt % water, and a radiation absorber, which can be in the form of particles dispersed therein at a concentration from about 0.1 wt % to about 15 wt % by solids weight, based on a total weight of the fusing agent. The particulate build material (110) can include polymeric particles suitable for use as a particulate build material in the methods described herein. Further details about the composition of the fusing agent and the particulate build material are described in greater detail below. The treatment agent (130) can include an aqueous solution of 4-hydroxybenzoate (also known as methyl paraben).

Fusing Agents

The fusing agents can be applied to the particulate build in areas that are to be fused together during three-dimensional printing. The fusing agent can include carbon black pigment particles as a radiation absorber. The carbon black pigment particles can absorb radiant energy and convert the energy to heat. As explained above, the fusing agent can be used with a particulate build material in a particular three-dimensional printing process. A thin layer of particulate build material can be formed, and then the fusing agent can be selectively applied to areas of the particulate build material that are desired to be consolidated to become part of the solid three-dimensional printed object. The fusing agent can be applied, for example, by printing such as with a fluid ejector or fluid jet printhead. Fluid jet printheads can jet the fusing agent in a similar way as an inkjet printhead jetting printing liquid. Accordingly, the fusing agent can be applied with great precision to certain areas of the particulate build material that are desired to form a layer of the final three-dimensional printed object. After applying the fusing agent, the particulate build material can be irradiated with radiant energy. The carbon black pigment particles from the fusing agent can absorb this energy and convert it to heat, thereby heating any polyamide particles in contact with the pigment particles. An appropriate amount of radiant energy can be applied so that the area of the particulate build material that was printed with the fusing agent heats up enough to melt the polyamide particles to consolidate the particles into a solid layer, while the particulate build material that was not printed with the fusing agent remains as a loose powder with separate particles.

In some examples, the amount of radiant energy applied, the amount of fusing agent applied to the powder bed, the concentration of radiation absorber in the fusing agent, and the preheating temperature of the powder bed (e.g., the temperature of the particulate build material prior to printing the fusing agent and irradiating) can be tuned to ensure that the portions of the powder bed printed with the fusing agent will be fused to form a solid layer and the unprinted portions of the powder bed will remain a loose powder. These variables can be referred to as parts of the “print mode” of the three-dimensional printing system. The print mode can include any variables or parameters that can be controlled during three-dimensional printing to affect the outcome of the three-dimensional printing process.

The process of forming a single layer by applying fusing agent and irradiating the powder bed can be repeated with additional layers of fresh particulate build material to form additional layers of the three-dimensional printed object, thereby building up the final object one layer at a time. In this process, the particulate build material surrounding the three-dimensional printed object can act as a support material for the object. When the three-dimensional printing is complete, the article can be removed from the powder bed and any loose powder on the article can be removed.

Accordingly, in some examples, the fusing agent can include a radiation absorber that is capable of absorbing electromagnetic radiation to produce heat. The radiation absorber can include carbon black pigment particles. These particles can effectively absorb radiation to generate heat. The particles also give the finished three-dimensional printed object a black appearance. In further examples, additional radiation absorbers may also be included. The radiation absorbers can be colored or colorless. In various examples, the radiation absorber can include carbon black pigment, metal dithiolene complex, a near-infrared absorbing dye, a near-infrared absorbing pigment, metal nanoparticles, a conjugated polymer, tungsten bronze, molybdenum bronze, or a combination thereof. Examples of near-infrared absorbing dyes include aminium dyes, tetraaryldiamine dyes, cyanine dyes, phthalocyanine dyes, dithiolene dyes, and others. In further examples, the radiation absorber can be a near-infrared absorbing conjugated polymer such as poly(3,4-ethylenedioxythiophene)-poly(styrenesulfonate) (PEDOT:PSS), a polythiophene, poly(p-phenylene sulfide), a polyaniline, a poly(pyrrole), a poly(acetylene), poly(p-phenylene vinylene), polyparaphenylene, or combinations thereof. As used herein, “conjugated” refers to alternating double and single bonds between atoms in a molecule. Thus, “conjugated polymer” refers to a polymer that has a backbone with alternating double and single bonds. In many cases, the radiation absorber can have a peak absorption wavelength in the range of about 800 nm to about 1400 nm.

A variety of near-infrared pigments can also be used. Non-limiting examples can include phosphates having a variety of counterions such as copper, zinc, iron, magnesium, calcium, strontium, the like, and combinations thereof. Non-limiting specific examples of phosphates can include M₂P₂O₇, M₄P₂O₉, M₅P₂O₁₀, Ma(PO₄)₂, M(PO₃)₂, M₂P₄O₁₂, and combinations thereof, where M represents a counterion having an oxidation state of +2, such as those listed above or a combination thereof. For example, M₂P₂O₇ can include compounds such as Cu₂P₂O₇, Cu/MgP₂O₇, Cu/ZnP₂O₇, or any other suitable combination of counterions. It is noted that the phosphates described herein are not limited to counterions having a +2 oxidation state. Other phosphate counterions can also be used to prepare other suitable near-infrared pigments.

Additional near-infrared pigments can include silicates. Silicates can have the same or similar counterions as phosphates. One non-limiting example can include M₂SiO₄, M₂Si₂O₆, and other silicates where M is a counterion having an oxidation state of +2. For example, the silicate M₂Si₂O₆ can include Mg₂Si₂O₆, Mg/CaSi₂O₆, MgCuSi₂O₆, Cu₂Si₂O₆, Cu/ZnSi₂O₆, or other suitable combination of counterions. It is noted that the silicates described herein are not limited to counterions having a +2 oxidation state. Other silicate counterions can also be used to prepare other suitable near-infrared pigments.

In further examples, the radiation absorber can include a metal dithiolene complex. Transition metal dithiolene complexes can exhibit a strong absorption band in the 600 nm to 1600 nm region of the electromagnetic spectrum. In some examples, the central metal atom can be any metal that can form square planer complexes. Non-limiting specific examples include complexes based on nickel, palladium, and platinum.

In further examples, the radiation absorber can include a tungsten bronze or a molybdenum bronze. In certain examples, tungsten bronzes can include compounds having the formula MₓWO₃, where M is a metal other than tungsten and x is equal to or less than 1. Similarly, in some examples, molybdenum bronzes can include compounds having the formula MₓMoO₃, where M is a metal other than molybdenum and x is equal to or less than 1.

A dispersant can be included in the fusing agent in some examples. Dispersants can help disperse the radiation absorbing pigments described above. In some examples, the dispersant itself can also absorb radiation. Non-limiting examples of dispersants that can be included as a radiation absorber, either alone or together with a pigment, can include polyoxyethylene glycol octylphenol ethers, ethoxylated aliphatic alcohols, carboxylic esters, polyethylene glycol ester, anhydrosorbitol ester, carboxylic amide, polyoxyethylene fatty acid amide, poly (ethylene glycol) p-isooctyl-phenyl ether, sodium polyacrylate, and combinations thereof.

The amount of radiation absorber in the fusing agent can vary depending on the type of radiation absorber. In some examples, the concentration of radiation absorber in the fusing agent can be from about 0.1 wt % to about 20 wt %. In one example, the concentration of radiation absorber in the fusing agent can be from about 0.1 wt % to about 15 wt %. In another example, the concentration can be from about 0.1 wt % to about 8 wt %. In yet another example, the concentration can be from about 0.5 wt % to about 2 wt %. In a particular example, the concentration can be from about 0.5 wt % to about 1.2 wt %. In one example, the radiation absorber can have a concentration in the fusing agent such that after the fusing agent is jetted onto the polyamide particles, the amount of radiation absorber in the polyamide particles can be from about 0.0003 wt % to about 10 wt %, or from about 0.005 wt % to about 5 wt %, with respect to the weight of the polymeric build material.

In some examples, the fusing agent can be jetted onto the polymeric build material using a fluid jetting device, such as inkjet printing architecture. Accordingly, in some examples, the fusing agent can be formulated to give the fusing agent good jetting performance. Ingredients that can be included in the fusing agent to provide good jetting performance can include a liquid vehicle. Thermal jetting can function by heating the fusing agent to form a vapor bubble that displaces fluid around the bubble, and thereby forces a droplet of fluid out of a jet nozzle. Thus, in some examples the liquid vehicle can include a sufficient amount of an evaporating liquid that can form vapor bubbles when heated. The evaporating liquid can be a solvent such as water, an alcohol, an ether, or a combination thereof.

In some examples, the liquid vehicle formulation can include a co-solvent or co-solvents present in total at from about 1 wt % to about 50 wt %, depending on the jetting architecture. Further, a non-ionic, cationic, and/or anionic surfactant can be present, ranging from about 0.01 wt % to about 5 wt %. In one example, the surfactant can be present in an amount from about 1 wt % to about 5 wt %. The liquid vehicle can include dispersants in an amount from about 0.5 wt % to about 3 wt %. The balance of the formulation can be purified water, and/or other vehicle components such as biocides, viscosity modifiers, material for pH adjustment, sequestering agents, preservatives, and the like. In one example, the liquid vehicle can be predominantly water.

In some examples, a water-dispersible or water-soluble radiation absorber can be used with an aqueous vehicle. Because the radiation absorber is dispersible or soluble in water, an organic co-solvent may not be present, as it may not be included to solubilize the radiation absorber. Therefore, in some examples the fluids can be substantially free of organic solvent, e.g., predominantly water. However, in other examples a co-solvent can be used to help disperse other dyes or pigments or enhance the jetting properties of the respective fluids. In still further examples, a non-aqueous vehicle can be used with an organic-soluble or organic-dispersible fusing agent.

Classes of co-solvents that can be used can include organic co-solvents including aliphatic alcohols, aromatic alcohols, diols, glycol ethers, polyglycol ethers, caprolactams, formamides, acetamides, and long chain alcohols. Examples of such compounds include 1-aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. Specific examples of solvents that can be used include, but are not limited to, 2-pyrrolidinone, N-methylpyrrolidone, 2-hydroxyethyl-2-pyrrolidone, 2-methyl-1,3-propanediol, tetraethylene glycol, 1,6-hexanediol, 1,5-hexanediol, 1,2-propanediol, and 1,5-pentanediol.

In certain examples, a high boiling point co-solvent can be included in the fusing agent. The high boiling point co-solvent can be an organic co-solvent that boils at a temperature higher than the temperature of the powder bed during printing. In some examples, the high boiling point co-solvent can have a boiling point above about 250° C. In still further examples, the high boiling point co-solvent can be present in the fusing agent at a concentration from about 1 wt % to about 4 wt %.

In certain examples, the fusing agent can include a polar organic solvent. As used herein, “polar organic solvents” can include organic solvents made up of molecules that have a net dipole moment or in which portions of the molecule have a dipole moment, allowing the solvent to dissolve polar compounds. The polar organic solvent can be a polar protic solvent or a polar aprotic solvent. Examples of polar organic solvents that can be used can include diethylene glycol, triethylene glycol, tetraethylene glycol, C3 to C6 diols, 2-pyrrolidone, hydroxyethyl-2-pyrrolidone, 2-methyl-1,3 propanediol, poly(propylene glycol) with 1, 2, 3, or 4 propylene glycol units, glycerol, and others. In some examples, the polar organic solvent can be present in an amount from about 0.1 wt % to about 20 wt % with respect to the total weight of the fusing agent.

Regarding the surfactant that may be present, a surfactant or surfactants can be used, such as alkyl polyethylene oxides, alkyl phenyl polyethylene oxides, polyethylene oxide block copolymers, acetylenic polyethylene oxides, polyethylene oxide (di)esters, polyethylene oxide amines, protonated polyethylene oxide amines, protonated polyethylene oxide amides, dimethicone copolyols, substituted amine oxides, and the like. The amount of surfactant added to the fusing agent may range from about 0.01 wt % to about 20 wt %. Suitable surfactants can include, but are not limited to, liponic esters such as TERGITO™ 15-S-12, TERGITOL™ 15-S-7 available from Dow Chemical Company (Michigan), LEG-1 and LEG-7; TRITON™ X-100; TRITON™ X-405 available from Dow Chemical Company (Michigan); and sodium dodecyl sulfate.

Various other additives can be employed to enhance certain properties of the fusing agent for specific applications. Examples of these additives are those added to inhibit the growth of harmful microorganisms. These additives may be biocides, fungicides, and other microbial agents, which can be used in various formulations. Examples of suitable microbial agents include, but are not limited to, NUOSEPT® (Nudex, Inc., New Jersey), UCARCIDE™ (Union carbide Corp., Texas), VANCIDE® (R.T. Vanderbilt Co., Connecticut), PROXEL® (ICI Americas, New Jersey), and combinations thereof.

Sequestering agents, such as EDTA (ethylene diamine tetra acetic acid), may be included to eliminate the deleterious effects of heavy metal impurities, and buffer solutions may be used to control the pH of the fluid. From about 0.01 wt % to about 2 wt %, for example, can be used. Viscosity modifiers and buffers may also be present, as well as other additives to modify properties of the fluid as desired. Such additives can be present at from about 0.01 wt % to about 20 wt %

Particulate Build Materials

Particulate build materials suitable in the present disclosure can include polymeric particles such as, but not limited to, polyamides. Example polyamides that may have utility in the current disclosure include polyamide-12, polyamide-6, polyamide-66, polyamide-69, polyamide 6-10, polyamide 6-12, polyamide-46, polyamide-1212 and combinations thereof.

In some examples the particulate build material may be in the form of powders. In another example the particulate build material may be in the form of, formed from, or may include, short fibres that may, for example, have been cut into short lengths from long strands or threads of material.

In further detail regarding the particulate build material, this material can include polyamide particles having a variety of shapes, such as substantially spherical particles or irregularly-shaped particles. In some examples, the polyamide particles can be capable of being formed into three-dimensional printed objects with a resolution of about 20 μm to about 100 μm, about 30 μm to about 90 μm, or about 40 μm to about 80 μm. As used herein, “resolution” refers to the size of the smallest feature that can be formed on a three-dimensional printed object. The polyamide particles can form layers from about 20 μm to about 100 μm thick, allowing the fused layers of the printed part to have roughly the same thickness. This can provide a resolution in the z-axis (i.e., depth) direction of about 20 μm to about 100 μm. The polyamide particles can also have a sufficiently small particle size and sufficiently regular particle shape to provide about 20 μm to about 100 μm resolution along the x-axis and y-axis (i.e., the axes parallel to the top surface of the powder bed). For example, the polyamide particles can have an average particle size from about 20 μm to about 100 μm. In other examples, the average particle size can be from about 20 μm to about 50 μm. Other resolutions along these axes can be from about 30 μm to about 90 μm or from 40 μm to about 80 μm.

As an example of polymeric build materials having utility in the present disclosure, the polyamide-12 particles can have a melting or softening point from about 175° C. to about 200° C. If other polymeric particles are included in the particulate build material, e.g., blended or composited with the polyamide-12 particles, examples of materials that may be present include particles of polyamide-6, polyamide-9, polyamide-11, polyamide-6,6, polyamide-6,12, polyamide copolyamide-12, polyethylene, wax, thermoplastic polyurethane, acrylonitrile butadiene styrene, amorphous polyamide, polymethylmethacrylate, ethylene-vinyl acetate, polyarylate, aromatic polyesters, silicone rubber, polypropylene, polyester, polycarbonate, copolymers of polycarbonate with acrylonitrile butadiene styrene, copolymers of polycarbonate with polyethylene terephthalate, polyether ketone, polyacrylate, polystyrene, polyvinylidene fluoride, polyvinylidene fluoride copolyamide-12, poly(vinylidene fluoride-trifluoroethylene), poly(vinylidene fluoride-trifluoroethylene-chlorotrifluoroethylene), or mixtures thereof. If a second type of polymer particle is included, in one example, the majority of the polymeric particles present can be polyamide-12, e.g., greater than 50 wt % of the polymer particles present in the particulate build material includes polyamide-12. In other examples, when multiple polymer particles are used, a weight ratio of polyamide-12 to all other polymer particles present can be from about 100:1 to about 1:1, or from about 20:1 to about 2:1, for example.

The polyamide particles can also in some cases be blended with a non-polymeric filler. The filler can include inorganic particles such as alumina, silica, fibers, carbon nanotubes, or combinations thereof. When the polyamide particles fuse together, the filler particles can become embedded in the polymer forming a composite material. In some examples, the filler can include a free-flow agent, anti-caking agent, or the like. Such agents can prevent packing of the powder particles, coat the powder particles and smooth edges to reduce inter-particle friction, and/or absorb moisture. In further examples, a filler can be encapsulated in polymer to form polymer encapsulated particles. For example, glass beads can be encapsulated in a polymer such as a polyamide to form polymer encapsulated particles. In some examples, a weight ratio of thermoplastic polymer to filler in the particulate build material can be from about 100:1 to about 1:2 or from about 5:1 to about 1:1.

In further examples the particulate build material can be a metallic particle or a ceramic particle. In still other examples these metallic particles or ceramic particles can be coated particles.

Treatment Agent

The treatment agent for the current disclosure can comprise water.

In another example, the treatment agent for the current disclosure can comprise an aqueous solution of methyl 4-hydroxybenzoate, also known as methyl paraben. In one example the treatment agent can be formulated with the methyl 4-hydroxybenzoate in solution at a concentration between about 0.01 wt % to about 1 wt % based on the total weight of the treatment agent. In another example the treatment agent can be formulated with the methyl 4-hydroxybenzoate in solution at a concentration between 0.1 wt % and 0.5 wt % based on the total weight of the treatment agent. In yet another example the treatment agent can be formulated with the methyl 4-hydroxybenzoate in solution at a concentration of about 0.25 wt % based on the total weight of the treatment agent.

In an example the treatment agent can be formulated by adding the methyl 4-hydroxybenzoate to water and then heating on a stir plate for several hours at a temperature between 80° C. and 95° C. Prior to use the treatment agent is then brought down to room temperature.

In one example the treatment agent is formulated by the addition of methyl 4-hydroxybenzoate to water at a concentration of between 0.01 wt % and 1 wt % based on the total weight of the treatment agent and then heated while stirring at a temperature of 90° C. for 24 hours. After this process the treatment agent is allowed to cool to room temperature before use.

The treatment agent can be applied by soaking or using an application unit, which can include equipment for applying liquids to a three-dimensional printed object. A liquid application unit can include a tank or well containing liquid for dipping a three-dimensional printed object or sprayers for spraying liquid onto a three-dimensional printed object. In certain examples, a liquid application unit can include a chamber in which a three-dimensional object can be enclosed and internal sprayers within the chamber can apply the liquid to the three-dimensional printed object. Thus, the term “soaking” does not infer that the three-dimensional object is being bathed in the treatment agent (though it may be), but rather that a coating of treatment agent is applied and remains on a surface of the three-dimensional object for the time period of the soaking so that the treatment agent can absorb into the surface during the soaking duration.

In further examples, it can be useful to wash excess treatment agent off of the three-dimensional printed object after soaking by whatever soaking method is used. The liquid application unit can also include equipment to wash the object, such as with soap and water. Alternatively, the three-dimensional printed object can be removed from the liquid application unit and washed elsewhere. In certain examples, a separate washing unit can be used.

In yet another example the three-dimensional printed object which has been treated with treatment agent can be washed by immersion in a sonic bath for a period of time.

Other Fluid Agents

In some more specific examples, in addition to the fusing agent and the treatment agent, there may be other fluid agents used, such as coloring agents, detailing agents or the like. A coloring agent may include a liquid vehicle and a colorant, such as a pigment and/or a dye. On the other hand, the three-dimensional printing kits can include a detailing agent. The detailing agent can include a detailing compound. The detailing compound can be capable of reducing the temperature of the particulate build material onto which the detailing agent is applied. In some examples, the detailing agent can be printed around the edges of the portion of the powder that is printed with the fusing agent. The detailing agent can increase selectivity between the fused and unfused portions of the powder bed by reducing the temperature of the powder around the edges of the portion to be fused.

In some examples, the detailing compound can be a solvent that evaporates at the temperature of the powder bed. In some cases the powder bed can be preheated to a preheat temperature within about 10° C. to about 70° C. of the fusing temperature of the polyamide-12 particles. Depending on the type of polyamide-12 particles used, the preheat temperature can be in the range of about 90° C. to about 200° C. or more. The detailing compound can be a solvent that evaporates when it comes into contact with the powder bed at the preheat temperature, thereby cooling the printed portion of the powder bed through evaporative cooling. In certain examples, the detailing agent can include water, co-solvents, or combinations thereof. Non-limiting examples of co-solvents for use in the detailing agent can include xylene, methyl isobutyl ketone, 3-methoxy-3-methyl-1-butyl acetate, ethyl acetate, butyl acetate, propylene glycol monomethyl ether, ethylene glycol mono tert-butyl ether, dipropylene glycol methyl ether, diethylene glycol butyl ether, ethylene glycol monobutyl ether, 3-Methoxy-3-Methyl-1-butanol, isobutyl alcohol, 1,4-butanediol, N,N-dimethyl acetamide, and combinations thereof. In some examples, the detailing agent can be mostly water. In a particular example, the detailing agent can be about 85 wt % water or more. In further examples, the detailing agent can be about 95 wt % water or more. In still further examples, the detailing agent can be substantially devoid of radiation absorbers. That is, in some examples, the detailing agent can be substantially devoid of ingredients that absorb enough radiation energy to cause the powder to fuse. In certain examples, the detailing agent can include colorants such as dyes or pigments, but in small enough amounts that the colorants do not promote fusion of the powder printed with the detailing agent when exposed to the radiation energy.

The detailing agent can also include ingredients to allow the detailing agent to be jetted by a fluid jet printhead. In some examples, the detailing agent can include jettability imparting ingredients such as those in the fusing agent described above. These ingredients can include a liquid vehicle, surfactant, dispersant, co-solvent, biocides, viscosity modifiers, materials for pH adjustment, sequestering agents, preservatives, and so on. These ingredients can be included in any of the amounts described above.

Three-Dimensional Printed Objects

The present disclosure also describes three-dimensional printed objects comprising a polymeric body including fused polymeric particles having a radiation absorber embedded as particles among the fused polymeric particles and a treatment agent imbibed into a surface of the polymeric body wherein the treatment agent comprises water.

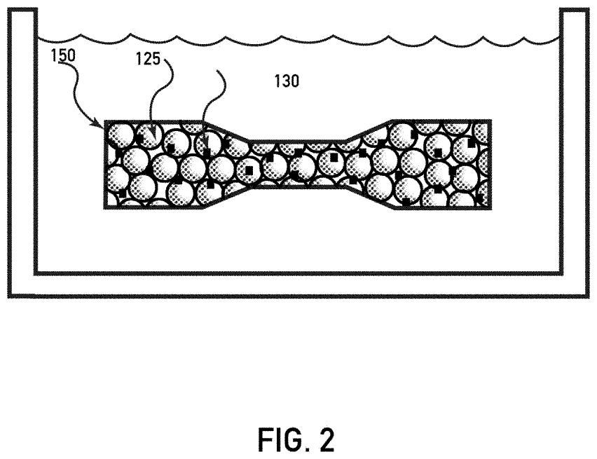

FIG. 2 illustrates an example where the three-dimensional printing kit (and methods described herein) is used to prepare a three-dimensional printed object. In this example, the three-dimensional printed object (250) is shown as being treated with the treatment agent (230). The three-dimensional printed object (250) is made up of fused polymeric polyamide particles (225) and radiation absorber particles (215) embedded among the fused polyamide particles (215)

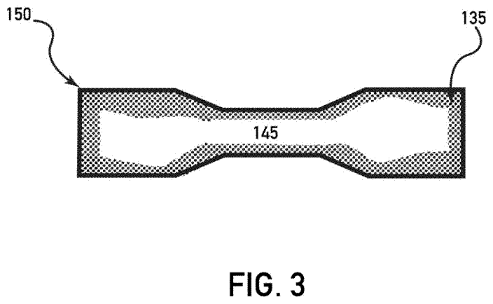

A three-dimensional printed object prepared using the three-dimensional printing kits and/or methods described herein is shown in FIG. 3 (350). For example, a three-dimensional printed object can include a polymeric body (345) including fused polyamide particles having radiation absorber embedded as particles among the fused polyamide particles (see FIG. 2 for fused polyamide particles and radiation absorber). The three-dimensional printed object can also include a treatment agent imbibed into a surface of the polymeric body (335). The treatment agent can comprise an aqueous solution of methyl 4-hydroxybenzoate at a concentration of between about 0.01 wt % and about 1 wt % methyl 4-hydroxybenzoate based on the total weight of the treatment agent.

In an example the three-dimensional printed object includes a radiation absorber in an amount from about 0.005 wt % to about 5 wt % with respect to the total weight of the three-dimensional printed object.

In an example the three-dimensional printed object is treated with a treatment agent at a temperature of from about room temperature to about 110° C. for a period of time of about 4 hours to about 1 month.

In another example the three-dimensional printed object exhibits a 350% strain at break or greater after treatment with the treatment agent.

Method of Enhancing Mechanical Properties of Three-Dimensional Printed Object

The current disclosure also describes a method of enhancing mechanical properties of a three-dimensional printed object comprising treatment of a three-dimensional printed object with a treatment agent at a temperature of from about 0° C. to about 100° C. for a period of time of about 4 hours to 1 month wherein the treatment agent comprises water and wherein the three-dimensional printed object comprises fused polymeric particles having radiation absorber embedded as particles among the fused polymeric particles. Fusing is commonly the process by which the particulate build material is heated above the glass transition temperature and more preferably above the melting point of the build material such that build material melts and fuses.

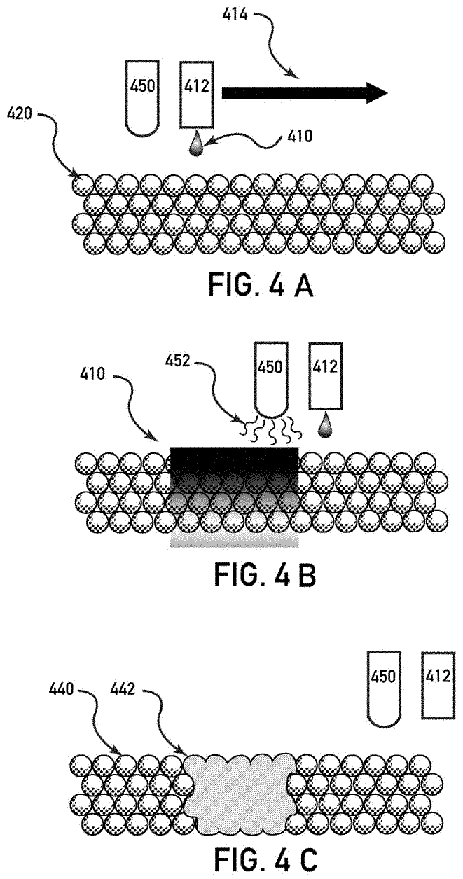

FIGS. 4A-C are an illustration of a possible process of forming the three-dimensional printed object prior to treatment with the treatment agent. In FIG. 4A, a fusing agent (410) is applied, e.g., jetted, onto a layer of particulate build material (420), which is part of a powder bed including the polyamide particles. The fusing agent is jetted from a fusing agent ejector (412) that can move across the layer of particulate build material in a given direction of movement (414) to selectively jet fusing agent on areas that are to be fused. A radiation source (450) is also shown, which is described in more detail in the context of FIG. 4B.

The system (400) is further described in FIG. 4B, which shows the layer of particulate build material (420) after the fusing agent (410) has been jetted onto an area of the layer that is to be fused. In this figure, the radiation source (450) is shown emitting radiation (452) toward the layer of polymeric build material, which includes the polyamide particles. The fusing agent can include any of the radiation absorbers previously described, provided it can absorb this radiation and convert the radiation energy to heat.

FIG. 4C shows a layer of particulate build material (420) with a fused portion (442) where the fusing agent was applied. This portion has reached a sufficient temperature to fuse the particulate build material (including the polyamide particles) together to form a solid polymer matrix. For context, the fusing agent ejector (412) and the radiation source (450) are shown in place to apply the next applications of fusing agent and radiation to the next layer of particulate build material applied thereon, to thereby continue to build the three-dimensional object iteratively.

In some examples, a detailing agent or some other agent (not shown) can also be jetted onto the powder bed. The detailing agent, for example, can be a fluid that reduces the maximum temperature of the polyamide particles on which the detailing agent is printed. In particular, the maximum temperature reached by the powder during exposure to radiation energy can be less in the areas where the detailing agent is applied. In certain examples, the detailing agent can include a solvent that evaporates from the polyamide particles to evaporatively cool the polyamide particles. The detailing agent can be printed in areas of the powder bed where fusing is not desired. In particular examples, the detailing agent can be printed along the edges of areas where the fusing agent is printed. This can give the fused layer a clean, defined edge where the fused polyamide particles end and the adjacent polyamide particles remain unfused. In other examples, the detailing agent can be printed in the same area where the fusing agent is printed to control the temperature of the area to be fused. In certain examples, some areas to be fused can tend to overheat, especially in central areas of large fused sections. To control the temperature and avoid overheating (which can lead to melting and slumping of the build material), the detailing agent can be applied to these areas.

The fusing agent and, in some cases, detailing agent can be applied onto the powder bed using fluid jet print heads, e.g., jetting, inkjetting or ejecting from printing architecture. The amount of the fusing agent used can be calibrated based the concentration of radiation absorber in the fusing agent, the level of fusing desired for the polyamide particles, and other factors. In some examples, the amount of fusing agent printed can be sufficient to contact the radiation absorber with the entire layer of polyamide particles. For example, if individual layers of polyamide particles are 100 microns thick, then the fusing agent can penetrate 100 microns into the polyamide particles. Thus, the fusing agent can heat the polyamide particles throughout the layer so that the layer can coalesce and bond to the layer below. After forming a solid layer, a new layer of loose powder can be formed, either by lowering the powder bed or by raising the height of a powder roller and rolling a new layer of powder.

In some examples, the powder bed as a whole can be preheated to a temperature below the melting or softening point of the polyamide particles. In one example, the preheat temperature can be from about 10° C. to about 30° C. below the melting or softening point. In another example, the preheat temperature can be within 50° C. of the melting or softening point. In a particular example, the preheat temperature can be from about 160° C. to about 170° C. and the polyamide particles can be polyamide particles. In another example, the preheat temperature can be about 90° C. to about 100° C. Preheating can be accomplished with a lamp or lamps, an oven, a heated support bed, or other types of heaters. In some examples, the entire powder bed can be heated to a substantially uniform temperature.

The powder bed can be irradiated with a fusing lamp. Suitable fusing lamps for use in the methods described herein can include commercially available infrared lamps and halogen lamps. The fusing lamp can be a stationary lamp or a moving lamp. For example, the lamp can be mounted on a track to move horizontally across the powder bed. Such a fusing lamp can make multiple passes over the bed depending on the amount of exposure to coalesce printed layers. The fusing lamp can be configured to irradiate the entire powder bed with a substantially uniform amount of energy. This can selectively coalesce the printed portions with fusing agent leaving the unprinted portions of the polyamide particles below the melting or softening point.

In one example, the fusing lamp can be matched with the radiation absorber in the fusing agent so that the fusing lamp emits wavelengths of light that match the peak absorption wavelengths of the radiation absorber. A radiation absorber with a narrow peak at a particular near-infrared wavelength can be used with a fusing lamp that emits a narrow range of wavelengths at approximately the peak wavelength of the radiation absorber. Similarly, a radiation absorber that absorbs a broad range of near-infrared wavelengths can be used with a fusing lamp that emits a broad range of wavelengths. Matching the radiation absorber and the fusing lamp in this way can increase the efficiency of coalescing the polyamide particles with the fusing agent printed thereon, while the unprinted polyamide particles do not absorb as much light and remain at a lower temperature.

Depending on the amount of radiation absorber present in the polyamide particles, the absorbance of the radiation absorber, the preheat temperature, and the melting or softening point of the polymer, an appropriate amount of irradiation can be supplied from the fusing lamp. In some examples, the fusing lamp can irradiate individual layers from about 0.5 to about 10 seconds per pass.

The three-dimensional printed object can be formed by jetting a fusing agent onto layers of powder bed build material according to a 3D object model. 3D object models can in some examples be created using computer aided design (CAD) software. 3D object models can be stored in any suitable file format. In some examples, a three-dimensional printed object as described herein can be based on a single 3D object model. The 3D object model can define the three-dimensional shape of the article. Other information may also be included, such as structures to be formed of additional different materials or color data for printing the article with various colors at different locations on the article. The 3D object model may also include features or materials specifically related to jetting fluids on layers of particulate build material, such as the desired amount of fluid to be applied to a given area. This information may be in the form of a droplet saturation, for example, which can instruct a three-dimensional printing system to jet a certain number of droplets of fluid into a specific area. This can allow the three-dimensional printing system to finely control radiation absorption, cooling, color saturation, and so on. All this information can be contained in a single 3D object file or a combination of multiple files. The three-dimensional printed object can be made based on the 3D object model. As used herein, “based on the 3D object model” can refer to printing using a single 3D object model file or a combination of multiple 3D object models that together define the article. In certain examples, software can be used to convert a 3D object model to instructions for a three-dimensional printer to form the article by building up individual layers of build material.

In an example of the three-dimensional printing process, a thin layer of polyamide particles can be spread on a bed to form a powder bed. At the beginning of the process, the powder bed can be empty because no polyamide particles have been spread at that point, or the first layer can be applied onto an existing powder bed, e.g., support powder that is not used to form the three-dimensional object. For the first layer, the polyamide particles can be spread onto an empty build platform. The build platform can be a flat surface made of a material sufficient to withstand the heating conditions of the three-dimensional printing process, such as a metal. Thus, “applying individual build material layers of polyamide particles to a powder bed” includes spreading polyamide particles onto the empty build platform for the first layer. In other examples, a number of initial layers of polyamide particles can be spread before the printing begins. These “blank” layers of particulate build material can in some examples number from about 10 to about 500, from about 10 to about 200, or from about 10 to about 100. In some cases, spreading multiple layers of powder before beginning the printing can increase temperature uniformity of the three-dimensional printed object. A fluid jet printing head, such as an inkjet print head, can then be used to print a fusing agent including a radiation absorber over portions of the powder bed corresponding to a thin layer of the 3D article to be formed. Then the bed can be exposed to electromagnetic energy, e.g., typically the entire bed. The electromagnetic energy can include light, infrared radiation, and so on. The radiation absorber can absorb more energy from the electromagnetic energy than the unprinted powder. The absorbed light energy can be converted to thermal energy, causing the printed portions of the powder to soften and fuse together into a formed layer. After the first layer is formed, a new thin layer of polyamide particles can be spread over the powder bed and the process can be repeated to form additional layers until a complete 3D article is printed. Thus, “applying individual build material layers of polyamide particles to a powder bed” also includes spreading layers of polyamide-particles over the loose particles and fused layers beneath the new layer of polyamide particles.

After the three-dimensional object has been initially formed using the process described above, the object can be treated with a treatment agent using any of the application methods described above. For example, the object can be dipped in treatment agent for a period of time as shown in FIG. 2. In further examples, the method can also include washing excess treatment agent off of the three-dimensional printed object, such as using soap and water. In various examples, the object can be washed by spraying with soap and water, soaking, scrubbing, or other methods.

Method of Making a Treated Three-Dimensional Printed Object

The current disclosure also describes a method of making a treated three-dimensional printed object comprising treatment of a three-dimensional printed object with a treatment agent at a temperature of from about 0° C. to about 100° C. for a period of time of about 4 hours to 1 month.

In one example the method of making a treated three-dimensional printed object starts with the creation of the three-dimensional printed object wherein a thin layer of particulate build material is deposited on a flat plate as a powder bed. Thereafter a fusing agent is applied, e.g., jetted, onto a layer of the particulate build material, which is part of a powder bed. The fusing agent is jetted from a fusing agent ejector that can move across the layer of particulate build material in a given direction of movement to selectively jet fusing agent on areas that are to be fused.

At the beginning of the process, the powder bed can be empty because no particulate build materials have been spread at that point, or the first layer can be applied onto an existing powder bed, e.g., support powder that is not used to form the three-dimensional object. For the first layer, the particulate build materials can be spread onto an empty build platform. The build platform can be a flat surface made of a material sufficient to withstand the heating conditions of the three-dimensional printing process, such as a metal. Thus, “applying individual particulate build material layers” includes spreading particulate build materials onto the empty build platform for the first layer. In other examples, a number of initial layers of particulate build materials can be spread before the printing begins. These “blank” layers of particulate build material can in some examples number from about 10 to about 500, from about 10 to about 200, or from about 10 to about 100. In some cases, spreading multiple layers of powder before beginning the printing can increase temperature uniformity of the three-dimensional printed object.

The fusing agent and, in some cases, detailing agent can be applied onto the powder bed using fluid jet print heads, e.g., jetting, inkjetting or ejecting from printing architecture. The amount of the fusing agent used can be calibrated based the concentration of radiation absorber in the fusing agent, the level of fusing desired for the particulate build materials, and other factors. In some examples, the amount of fusing agent printed can be sufficient to contact the radiation absorber with the entire layer of particulate build materials. For example, if individual layers of particulate build materials are 100 microns thick, then the fusing agent can penetrate 100 microns into the particulate build materials. Thus, the fusing agent can heat the particulate build materials throughout the layer so that the layer can coalesce and bond to the layer below. After forming a solid layer, a new layer of loose powder can be formed, either by lowering the powder bed or by raising the height of a powder roller and rolling a new layer of powder

The powder bed can be irradiated with a fusing lamp. Suitable fusing lamps for use in the methods described herein can include commercially available infrared lamps and halogen lamps. The fusing lamp can be a stationary lamp or a moving lamp. For example, the lamp can be mounted on a track to move horizontally across the powder bed. Such a fusing lamp can make multiple passes over the bed depending on the amount of exposure to coalesce printed layers. The fusing lamp can be configured to irradiate the entire powder bed with a substantially uniform amount of energy. This can selectively coalesce the printed portions with fusing agent leaving the unprinted portions of the polyamide particles below the melting or softening point.

After the first layer is formed, a new thin layer of particulate build materials can be spread over the powder bed and the process can be repeated to form additional layers until a complete 3D article is printed. Thus, “applying individual build material layers of particulate build materials to a powder bed” also includes spreading layers of particulate build materials over the loose particles and fused layers beneath the new layer of particulate build materials.

Once the three-dimensional printed object is completed it is removed from the unfused particulate build material and any stray unfused particulate build materials are removed from the final part yielding a three-dimensional printed object. At this point the three-dimensional printed object can be further treated as described in the present disclosure.

The treatment agent can be applied by soaking or using an application unit, which can include equipment for applying liquids to a three-dimensional printed object. A liquid application unit can include a tank or well containing liquid for dipping a three-dimensional printed object or sprayers for spraying liquid onto a three-dimensional printed object. In certain examples, a liquid application unit can include a chamber in which a three-dimensional object can be enclosed and internal sprayers within the chamber can apply the liquid to the three-dimensional printed object. Thus, the term “soaking” does not infer that the three-dimensional object is being bathed in the treatment agent (though it may be), but rather that a coating of treatment agent is applied and remains on a surface of the three-dimensional object for the time period of the soaking so that the treatment agent can absorb into the surface during the soaking duration.

In one example the three-dimensional printed object can be treated with a treatment agent by soaking the three-dimensional printed object in a tank of water for a length of time ranging from 2 hours to several weeks.

In another example, a three-dimensional printed object is submerged in a treatment agent comprising methyl 4-hydroxybenzoate and water for a length of time ranging from 2 hours to several weeks.

In another example, a method of creating a treated three-dimensional printed object can include treatment of a three-dimensional printed object in a treatment agent comprising an aqueous solution of methyl 4-hydroxybenzoate at a temperature from about 0° C. to about 110° C. for a period of time ranging from about 2 hours to about one month. The treatment agent can comprise an aqueous solution of methyl 4-hydroxybenzoate of between about 0 wt % and about 1 wt % methyl 4-hydroxybenzoate and water.

### Definitions

It is noted that, as used in this specification and the appended claims, the singular forms “a,” “an,” and “the” include plural referents unless the content clearly dictates otherwise.

The term “about” as used herein, when referring to a numerical value or range, allows for a degree of variability in the value or range, for example, within 10%, or, in one aspect within 5%, of a stated value or of a stated limit of a range. The term “about” when modifying a numerical range is also understood to include as one numerical subrange a range defined by the exact numerical value indicated, e.g., the range of about 1 wt % to about 5 wt % includes 1 wt % to 5 wt % as an explicitly supported sub-range.

As used herein, “kit” can be synonymous with and understood to include a plurality of multiple components where the different components can be separately contained (though in some instances co-packaged in separate containers) prior to use, but these components can be combined together during use, such as during the three-dimensional object build processes described herein. The containers can be any type of a vessel, box, or receptacle made of any material.

As used herein, “applying” when referring to a fluid agent that may be used, for example, refers to any technology that can be used to put or place the fluid, e.g., fusing agent, fluid recycling agent, detailing agent, coloring agent, or the like on the polymeric build material or into a layer of polymeric build material for forming a three-dimensional object. For example, “applying” may refer to a variety of dispensing technologies, including “jetting,” “ejecting,” “dropping,” “spraying,” or the like.

As used herein, “jetting” or “ejecting” refers to fluid agents or other compositions that are expelled from ejection or jetting architecture, such as ink-jet architecture. Ink-jet architecture can include thermal or piezoelectric architecture. Additionally, such architecture can be configured to print varying drop sizes such as up to about 20 picoliters, up to about 30 picoliters, or up to about 50 picoliters, etc. Example ranges may include from about 2 picoliters to about 50 picoliters, or from about 3 picoliters to about 12 picoliters.

As used herein, “average particle size” refers to a number average of the diameter of the particles for spherical particles, or a number average of the volume equivalent sphere diameter for non-spherical particles. The volume equivalent sphere diameter is the diameter of a sphere having the same volume as the particle. Average particle size can be measured using a particle analyzer such as the MASTERSIZER™ 3000 available from Malvern Panalytical (United Kingdom). The particle analyzer can measure particle size using laser diffraction. A laser beam can pass through a sample of particles and the angular variation in intensity of light scattered by the particles can be measured. Larger particles scatter light at smaller angles, while small particles scatter light at larger angles. The particle analyzer can then analyze the angular scattering data to calculate the size of the particles using the Mie theory of light scattering. The particle size can be reported as a volume equivalent sphere diameter.

As used herein, a plurality of items, structural elements, compositional elements, and/or materials may be presented in a common list for convenience. However, these lists should be construed as though the individual member of the list is identified as a separate and unique member. Thus, no individual member of such list should be construed as a de facto equivalent of any other member of the same list based on presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, as well as to include all the individual numerical values or sub-ranges encompassed within that range as the individual numerical value and/or sub-range is explicitly recited. For example, a weight ratio range of about 1 wt % to about 20 wt % should be interpreted to include the explicitly recited limits of 1 wt % and 20 wt % and to include individual weights such as about 2 wt %, about 11 wt %, about 14 wt %, and sub-ranges such as about 10 wt % to about 20 wt %, about 5 wt % to about 15 wt %, etc.

### EXAMPLES

The following examples illustrate the present disclosure. However, it is to be understood that the following are merely illustrative of the application of the principles of the present disclosure. Numerous modifications and alternative devices, methods and systems may be devised without departing from the spirit and scope of the present disclosure. The appended claims are intended to cover such modifications and arrangements.

### Example 1 Heated Methyl 4-hydroxybenzoate Treatment

Several sample three-dimensional objects were printed in the shape of “dogbones” using an HP Multi-jet Fusion 3D® Printer. The build material was polyamide-12 powder and the fusing agent included carbon black pigment as a radiation absorber.

Once printed and decaked the polyamide three-dimensional printed dogbones were soaked in a treatment agent. The treatment agent was formulated by diluting 0.25 g of methyl 4-hydroxybenzoate (Acros Organics) in 99.75 ml of water and stirring for 24 hours at 90° C. Afterwards the solution was brought to room temperature and three-dimensional printed dogbones were placed in the treatment agent and allowed to sit for 168 hours.

### Example 2 Unheated Methyl 4-hydroxybenzoate Treatment

Three-dimensional printed objects were made in the shape of “dogbones” using an HP Multi-jet Fusion 3D® Printer. The build material was polyamide-12 powder and the fusing agent included carbon black pigment as a radiation absorber.

Once printed and decaked the polyamide three-dimensional printed dogbones were soaked in a treatment agent. The treatment agent was formulated by diluting 0.25 g of methyl 4-hydroxybenzoate (Acros Organics Fairlawn, N.J.) in 99.75 ml of water and stirring for 24 hours at room temperature. Afterwards the three-dimensional printed dogbone was placed in the solution and allowed to sit for 168 h

### Example 3 Water Treatment

Three-dimensional printed objects were made in the shape of “dogbones” using an HP Multi-jet Fusion 3D® Printer. The build material was polyamide-12 powder and the fusing agent included carbon black pigment as a radiation absorber.

Once printed and decaked the polyamide three-dimensional printed dogbones were soaked in a treatment agent of water. The three-dimensional printed dogbones were placed in the treatment agent and allowed to sit for 168 h

### Example 4 Comparative H250 Treatment

Three-dimensional printed objects were made in the shape of “dogbones” using an HP Multi-jet Fusion 3D® Printer. The build material was polyamide-12 powder and the fusing agent included carbon black pigment as a radiation absorber. The sample dog bones were divided into . . . .

Once printed and decaked the polyamide three-dimensional printed dogbones were soaked in a plasticizing solution of Sensatis® H250 trimethylene glycol (Allessa, Germany) for 168 hours.

### Example 5

The dogbones from the previous examples were then placed on an Instron Tensile Testing unit (Instron Corp. Norwood, Mass.) and the following was measured: tensile stress at maximum load (MPa), Young's Modulus (MPa) and % Strain at Break. The results are shown in Table 1 below.

TABLE 1

| | Tensile | | |
|---|---|---|---|
| | Stress at | | |
| | Maximum | Young’s | % Strain |
| | Load | Modulus | at Break |
| Sample ID | (MPa) | (MPa) | (%) |
| Untreated Control 1 | 47.061 | 1525.498 | 299.99 |
| Untreated Control 2 | 48.223 | 1567.273 | 99.14 |
| Heated methyl 4-hydroxybenzoate | 44.902 | 1278.752 | 441.15 |
| treated Sample 1 | | | |
| Heated methyl 4-hydroxybenzoate | 44.826 | 1345.259 | 452.57 |
| treated Sample 2 | | | |
| Unheated methyl 4-hydroxybenzoate | 45.935 | 1285.816 | 439.91 |
| treated Sample 1 | | | |
| Unheated methyl 4-hydroxybenzoate | 45.32 | 1384.953 | 404.07 |
| treated Sample 2 | | | |
| Water treatment Sample 1 | 44.334 | 1322.6038 | 353.88 |
| Comparative (H250) treated | 47.829 | 1516.996 | 78.91 |
| Sample 1 | | | |
| Comparative (H250) treated | 48.476 | 1600.234 | 96.98 |
| Sample 2 | | | |

It can be seen from this data that the trimethylene glycol (H250) samples have similar strength features to the control (untreated) samples. But the samples that were treated with water or methyl 4-hydroxybenzoate (heated and unheated) all show significant reduction in Tensile Stress at Maximum Load and Young's Modulus as well as significantly higher % Strain at Break. The selection of plasticizer is, indeed, a factor since H250 is a known plasticizer but it did not result in significant improvement like the methyl 4-hydroxybenzoate did.

What is claimed is:

1. A three-dimensional printed object, comprising:
a polymeric body including fused polymeric particles having a radiation absorber embedded as particles among the fused polymeric particles;
and a treatment agent imbibed into a surface of the polymeric body, wherein the treatment agent comprises water.

2. The three-dimensional printed object of claim 1, wherein the three-dimensional printed object is treated with a treatment agent at a temperature of from about room temperature to about 110° C. for a period of time of about 4 hours to about 1 month.

3. The three-dimensional printed object of claim 1, wherein the three-dimensional printed object includes the radiation absorber in an amount from about 0.005 wt % to about 5 wt % with respect to the total weight of the three-dimensional printed object.

4. The three-dimensional printed object of claim 1, wherein three-dimensional printed object exhibits a 350% strain at break or greater after treatment with the treatment agent.

5. The three-dimensional printed object of claim 1, wherein the treatment agent further comprises 0.1 wt % to 0.5 wt % methyl 4-hydroxybenzoate based on the total weight of the treatment agent.

6. A method of enhancing mechanical properties of a three-dimensional printed object comprising:
at least partially submerging a three-dimensional printed object in a treatment agent at a temperature of from about 0° C. to about 110° C. for a period of time of about 4 hours to about 1 month,
wherein the treatment agent comprises water,
wherein the three-dimensional printed object comprises fused polymeric particles having radiation absorber embedded as particles among the fused polymeric particles.

7. The method of claim 6, wherein the treatment agent further comprises 0.1 wt % to 0.5 wt % methyl 4-hydroxybenzoate based on the total weight of the treatment agent.

8. The method of claim 6, wherein the polymeric particles comprise polyamide particles.

9. The method of claim 6, wherein the polymeric particles are selected from the group consisting of polyamide-12, polyamide-6, polyamide-66, polyamide-69, polyamide 6-10, polyamide 6-12, polyamide-46, polyamide-1212 and combinations thereof.

10. The method of claim 6, wherein the radiation absorber is selected from the group consisting of carbon black pigment, metal dithiolene complex, a near-infrared absorbing dye, a near-infrared absorbing pigment, metal nanoparticles, a conjugated polymer, tungsten bronze, molybdenum bronze, and combinations thereof.

11. The method of claim 5, further comprising washing the surface of the three-dimensional printed object after treatment with the treatment agent.

12. The method of claim 11, wherein the washing includes immersion in an aqueous soap solution.

13. A method of creating a three-dimensional printed object followed by treatment with a treatment agent comprising:
spreading a thin layer of particulate build material;
applying a fusing agent to portions of the layer of particulate build material;
fusing the particulate build material thus contacted by the fusing agent using a radiation source;
repeating these operations until a complete three-dimensional article is printed;
followed by removing the three-dimensional printed object from the unfused polymeric particles;
and then at least partially submerging a three-dimensional printed object in a treatment agent at a temperature of from about 0° C. to about 110° C. for a period of time of about 4 hours to about 1 month,
wherein the treatment agent comprises water.

14. The method of claim 13, wherein the treatment agent further comprises 0.1 wt % to 0.5 wt % methyl 4-hydroxybenzoate based on the total weight of the treatment agent.

15. The method of claim 13, further comprising washing the surface of the three-dimensional printed object after treatment with the treatment agent.
